(19) United States
(12) Patent Application Publication
(10) Pub. No.: US 2021/0006482 A1
(43) Pub. Date: Jan. 7, 2021

(54) BROADBAND COMMUNICATION LINK PERFORMANCE MONITORING METHOD FOR COMMUNICATION DEVICES

(71) Applicant: ASSIA SPE, LLC, Wilmington, DE (US)

(72) Inventors: Chan-Soo HWANG, Sunnyvale, CA (US); John M. CIOFFI, Atherton, CA (US); Philip BEDNARZ, Palo Alto, CA (US); Sahand GOLNARIAN, Redwood City, CA (US); Lan Ke, Fremont, CA (US); Carlos GARCIA HERNANDEZ, Campbell, CA (US); Manikanden BALAKRISHNAN, Foster City, CA (US)

(73) Assignee: ASSIA SPE, LLC, Wilmington, DE (US)

(21) Appl. No.: 16/937,570

(22) PCT Filed: Jan. 30, 2019
(86) PCT No.: PCT/US2019/015837

§ 371 Date: Jul. 23, 2020

Related U.S. Application Data
(60) Provisional application No. 62/756,032, filed on Nov. 5, 2018.
(60) Provisional application No. 62/624,475, filed on Jan. 31, 2018.

(51) Int. Cl. H04L 12/26

(52) U.S. Cl. CPC H04L 43/0852; H04L 43/50; H04L 43/0888

(57) ABSTRACT

Presented are systems and methods for monitoring communication link performance between a communication device located behind a NAT, which is coupled to a communication device via a communication link, while enabling NAT traversal. Various embodiments utilize periodic transmissions of a short burst of communication packets between communication devices to monitor communication link performance. To monitor whether a link can support a particular service, a minimum required data rate of the service may be compared to a lower bound of the throughput measured by the dispersion of packets and by detecting excessive queueing delay. Once a problem is detected, a more accurate performance measurement may be triggered. Periodic communication enables NAT traversal via NAT hole puncturing. Overall, communication devices may maintain connection across a NAT, while monitoring communication link performance.

### BACKGROUND

The present disclosure claims priority to U.S. Provisional Patent Application No. 62/624,475, entitled, “BROADBAND COMMUNICATION LINK PERFORMANCE MONITORING METHOD FOR COMMUNICATION DEVICES,” naming as inventor Chan-Soo Hwang, and filed Jan. 31, 2018, and claims priority to U.S. Provisional Patent Application No. 62/756,032, entitled, “BROADBAND COMMUNICATION LINK PERFORMANCE MONITORING METHOD FOR COMMUNICATION DEVICES”, naming as inventors Chan-Soo Hwang, Philip Bednarz, John Matthew Cioffi, Manikanden Balakrishnan, Carlos Garcia Hernandez, Lan Ke, Sahand Golnarian, and filed on Nov. 5, 2018, and claims priority to the 371 International Application No. PCT/US 2019/015837, entitled, “SYSTEMS AND METHODS FOR BROADBAND COMMUNICATION LINK PERFORMANCE MONITORING”, naming as inventors Chan-Soo Hwang, John M. Cioffi, Philip Bednarz, Sahand Golnarian, Lan Ke, Carlos Garcia Hernandez, Manikanden Balakrishnan, and filed on Jan. 30, 2019, which application is hereby incorporated herein by reference in its entirety.

### TECHNICAL FIELD

The present disclosure relates generally to systems and methods for managing communication systems. More particularly, the present disclosure relates to systems, devices and methods for monitoring operation and performance of one or more communications links within a communication network.

### BACKGROUND

The complexity of modern communication network systems presents a great challenge to managing communication links in an efficient manner. One important aspect of link management is throughput, which is commonly measured by transferring a large file between two communication devices in a network. The resulting traffic tends to degrade the performance of user payload traffic within the network. In addition, in metered access networks, the file transfer is counted toward data usage, which may trigger throughput throttling or a data usage charges, thus, rendering downloading large files an unsuitable method for continuous monitoring of link performance.

Packet pairing is a common technique to measure link throughput by consecutively sending two packets, measuring the dispersion between correspondingly received timestamps, and computing throughput by dividing packet size by dispersion. While this approach reduces the impact on user payload traffic performance, the measurements require highly accurate timestamps, which may be not suitable to certain network architectures. For example, many access networks employ traffic shaping to limit maximum data-rate. To measure the throughput that an end-user experiences, the measurement scheme needs to send a sufficient number of packets to trigger traffic shaping so as to avoid over-estimating the actual end-user throughput. Since the packet pairing method sends only two packets, it does not trigger traffic shaping and, thus, oftentimes over-estimates the throughput of the access network in the presence of a traffic shaper. Cross-traffic may cause an increase in packet dispersion due to additional queueing delay at the router when multiple traffics intersect, which may cause the packet pairing to under-estimate the actual throughput on the link. Packet train dispersion may improve the throughput estimation accuracy by increasing the number of transmitted packets and applying statistical analysis. Packet train dispersion may also be used to detect the presence of traffic shaping. Unfortunately, the injection of a packet train may negatively impact payload traffic performance and typically cannot be used to continuously monitor the performance of an access network.

Communication devices behind a gateway have no public IP address and, thus, cannot be reached from outside of the network. Network Address Translation (NAT) techniques are used to translate an address between a private IP address/port pair and a public IP address/port pair. Oftentimes, NAT uses a translation table that contains entries that map private IP address/port pair(s) to public IP address/port pair(s). An entry may be deleted if a communication session is inactive for a certain timeout duration. The IP address relationship between many home network devices and external networks may be maintained using NAT hole punching, whereby “keep-alive IP packets” are periodically exchanged with an external server to keep entries in the NAT table. However, the packets used for NAT hole punching are not well-suited for monitoring access network performance.

Accordingly, what is needed are systems, devices, and methods that can efficiently and continuously monitor communication link performance while overcoming the shortcomings of existing methods.

### SUMMARY OF THE PRESENT DISCLOSURE

Embodiments of the present disclosure describe a method that continuously monitors an access network and determines whether the access network supports a service type of interest and accurately measures link throughput with little or no impact on payload traffic performance, while enabling NAT hole punching. In embodiments, an agent (e.g., hardware and/or software) located behind a NAT periodically measures the packet dispersion by transmitting/receiving a short burst of communication packets to or from a remote/outside server and determines whether a link can support a particular service type by comparing the minimum required data rate of the service to the lower bound of throughput estimated from the packet dispersion. The frequency of occurrence of this transmission may be adjusted such that NAT hole punching may be maintained. When more accurate throughput measurement is desired, embodiments of the present disclosure may measure data transfer throughput without degrading user payload traffic by using certain protocols (e.g., Lower-Than-Best-Effort Transport Protocols, such as Low Extra Delay Background Transport (LEDBAT)), such that, in the presence user payload traffic, the transmission rate is decreased such as to avoid interference with the user payload traffic.

In embodiments, the method for periodically monitoring the communication link performance while enabling NAT traversal comprises: (1) transmitting at least one communication packet, which comprises a timestamp and an identifier, by a first communication device behind a NAT and coupled to a second communication device via a network that comprises a communication link; (2) measuring the time of the arrival of the communication packet at the second communication device; (3) deriving a communication performance from the timestamp in the packet and the measured time of the arrival at the second communication device; (4) acknowledging the received packets by sending packets comprising a timestamp, an identifier, and sequence number by the second communication device that acknowledges received packets by comprising a (receive) timestamp, a (receive) identifier, and a sequence number; (5) measuring the time of the arrival of the communication packets at the first communication device; (6) deriving the communication performance from the timestamp in the packet and the measured time of the arrival at the first communication device; (7) triggering the measurement of throughput of the communication link by the first communication device if a trigger condition is met. In certain embodiments, throughput measurement is triggered if the lower bound of a throughput estimate is lower than a predefined threshold, or if a timer expires. In embodiments, throughput is measured by transferring large amounts of data using certain protocols (e.g., Lower-Than-Best-Effort transport protocols), such that the throughput measurement does not degrade user payload traffic performance.

### BRIEF DESCRIPTION OF THE DRAWINGS

References will be made to embodiments of the present disclosure, examples of which may be illustrated in the accompanying figures. These figures are intended to be illustrative, not limiting. Although the present disclosure is generally described in the context of these embodiments, it should be understood that it is not intended to limit the scope of the present disclosure to these particular embodiments. Items in the figures are not to scale.

FIG. 1 is a block diagram of a communication link monitoring system according to various embodiments of the present disclosure.

FIG. 2 is an exemplary flowchart illustrating a method for monitoring a communication link by an agent according to various embodiments of the present disclosure.

FIG. 3 is an exemplary flowchart illustrating a method for monitoring a communication link at a server according to various embodiments of the present disclosure.

FIG. 4 illustrates an exemplary probing packet structure according to various embodiments of the present disclosure.

FIG. 5 depicts an operation for estimating broadband performance according to various embodiments of the present disclosure.

FIG. 6 illustrates an exemplary speed of Internet payload traffic and Internet speed test, according to various embodiments of the present disclosure.

FIG. 7 illustrates an exemplary system for speed of Internet payload traffic and Internet speed test, according to embodiments of the present disclosure.

FIG. 8 depicts a simplified block diagram of a computing device/information handling system, in accordance with embodiments of the present disclosure.

### DETAILED DESCRIPTION OF EMBODIMENTS

In the following description, for purposes of explanation, specific details are set forth in order to provide an understanding of the present disclosure. It will be apparent, however, to one skilled in the art that the present disclosure can be practiced without these details. Furthermore, one skilled in the art will recognize that embodiments of the present disclosure, described below, may be implemented in a variety of ways, such as a process, an apparatus, a system, a device, or a method on a tangible computer-readable medium.

Components, or modules, shown in diagrams are illustrative of exemplary embodiments of the present disclosure and are meant to avoid obscuring the present disclosure. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the present disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated.

The terms “include,” “including,” “comprise,” and “comprising” shall be understood to be open terms and any lists the follow are examples and not meant to be limited to the listed items. Any headings used herein are for organizational purposes only and shall not be used to limit the scope of the description or the claims. Each reference mentioned in this patent document is incorporate by reference herein in its entirety.

Furthermore, one skilled in the art shall recognize that: (1) certain steps may optionally be performed; (2) steps may not be limited to the specific order set forth herein; (3) certain steps may be performed in different orders; and (4) certain steps may be done concurrently.

In this document the terms “average speed of payload downstream traffic,” “payload downstream rate,” and “user payload traffic speed” are used interchangeably. Similarly, the terms “Internet downstream speed test” and “speed test downstream rate” are used interchangeably, and “download speed for Internet speed test” and “traffic rate of speed test traffic,” are used interchangeably. Further, a location is considered “behind” a device if that location is further away from the Internet/cloud than the device.

Although the present disclosure is described in the context of “maximum,” or “average,” values, a person of skill in the art will appreciate that other statistical measures, such as averages, median, percentile, standard deviation, variance, variation, maximum, minimum, and n-th order statistics may be used. Similarly, the systems and methods described with respect to downstream measurements may be equally applied to upstream measurements.

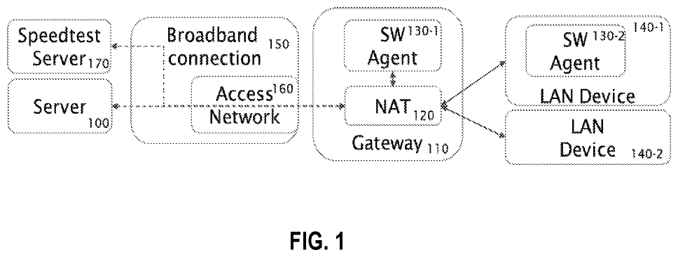

FIG. 1 is a block diagram of a communication link monitoring system according to various embodiments of the present disclosure. In embodiments, the system in FIG. 1 continuously and concurrently determines whether an access network supports a service type of interest and enables NAT traversal. The system may accurately measure link throughput with a reduced effect on payload traffic performance. The system comprises a server 100, a gateway 110, and LAN devices 140. The gateway 110 is coupled to the server 100 via broadband connection 150. In the example in FIG. 1, an agent 130-1 resides within a gateway 110, and an agent 130-2 resides within a LAN device 140-1. An access network 160 may be part of the broadband connection 150, which connects the gateway 110 to the Internet or other network. For example, access network 160 may be a DSL system or a cable modem system. The broadband connection 150 may experience problems such as a low throughput, excessive latency, an outage or other problems known to one of skill in the art. Such problems may occur at various locations within a network, including the access network 160.

An agent 130 may be located behind an NAT 120 and communicate with the server 100 using NAT traversal operations. LAN devices 140 are coupled to gateway 110 and located behind the NAT 120. One skilled in the art will recognize that the LAN devices 140 use NAT traversal operations in order to communicate with server via an address translation procedure within the NAT 120.

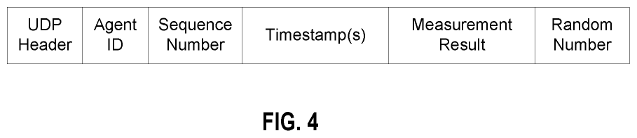

In operation, the agent 130 may periodically send at least one communication packet to the server 100. The rate at which communication packets are sent may be fixed, variable, configurable, or otherwise controlled, e.g., by the agent 130 itself or by some external source (not shown). The packet may comprise information, such as a timestamp and the identity of the agent, that enables link measurement and may be used to monitor an upstream performance of the broadband connection 150. In certain instances, the period is set shorter than the NAT binding timeout to maintain a NAT hole. The agent 130 may trigger more accurate broadband throughput measurements if appropriate, e.g., by sending a large file. When the server 100 receives the packets from the agent 130, the server 100 measures the time of the arrival of the communication packet and derives from the timestamp in the received packet and the measured time of the arrival one or more communication performance metrics, as will be discussed with reference to FIG. 4. The server 100 may then send one or more acknowledgement packets back to the agent 130. The communication packets may comprise information such as the timestamp that is used to monitor the downstream performance of the broadband connection. Moreover, the communication packets could have the information that can be used to discover round-trip performance or upstream performance of the broadband connection.

In embodiments, the agent 130 measures the time of the arrival of the communication packets from the server 100. Then, the agent 130 derives one or more communication performances from the timestamp in the received packet and the measured arrival time of the packets. The agent 130 may initiate or request more accurate throughput measurement of upstream or downstream broadband connection, for example if a problem in the broadband connection is detected. In embodiments, an accurate throughput may be measured by transferring large files between the agent 130 and a speedtest server 170. In certain examples, the speedtest server 170 is embedded in the server 100.

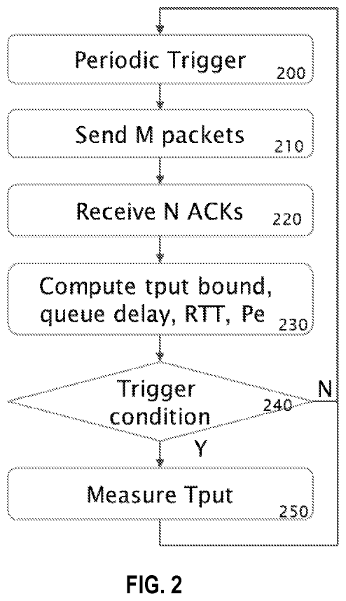

FIG. 2 is an exemplary flowchart illustrating a method for monitoring a communication link by an agent according to various embodiments of the present disclosure. The method may be applied by a system such as the system shown in FIG. 1 or by other systems that fall under the scope and spirit of the present disclosure.

In certain embodiments, the agent 130 performs steps enabling the detection of link performance using the steps set forth and/or combinations with supplemental steps thereof. The process may begin when a trigger 200, e.g., an agent that periodically triggers the transmission of packets to a server. In certain examples, a triggering period may be set shorter than or equal to a NAT binding timeout to maintain a NAT hole. In embodiments, when no prior knowledge about the NAT binding timeout exists, the periodic trigger may test different periods, monitor the acknowledgement packets from the server, and determine a periodicity with which the agent 130 receives acknowledgement packets. If triggered, the agent 130 may transmit M packets 210 to the server 100, where M is larger than or equal to one.

FIG. 4 illustrates an exemplary probing packet structure according to various embodiments of the present disclosure. One skilled in the art will recognize that the packet architecture of a transmitted packet may be modified, supplemented or otherwise changed to allow link monitoring. In example in FIG. 4, the packet comprises UDP header, agent identity (ID), a sequence number, and a timestamp when the packet was sent. In addition, the packet may comprise measurement results from prior packet exchanges, or other parameters, which allow the server 100 or agent 130 to better evaluate a link, e.g., link quality. If a large packet is desirable to improve the accuracy of monitoring, the agent 130 may add a random data to a transmitted packet. Third, the agent 130 receives N acknowledge packets from the server 100 and may obtain a timestamp for each received packet, as shown in 220 of FIG. 2.

In embodiments, the agent 130 derives a communication performance metric based on a timestamp obtained at step 230 and the information in a receive packet. The communication performance metric may comprise a queue delay, latency, round-trip-time (RTT), probability of error, lower bound of the downstream throughput, and a probability that a downstream throughput is below a threshold, e.g., a threshold defined by a minimum downstream throughput for supporting certain services such as IPTV or the minimum speed promised by a broadband provider. One skilled in the art will recognize that other link characteristics may be monitored and/or identified using various embodiments of the present disclosure.

At step 240 in FIG. 2, the agent 130 may trigger a more accurate throughput test, e.g., if a trigger condition is satisfied. If the trigger condition is not satisfied, the agent 130 may return to periodic trigger step 200. In embodiments, a more accurate throughput measurement is triggered when the lower bound of the throughput is less than a predetermined threshold, e.g., the minimum throughput that supports certain services such as IPTV. In embodiments, the throughput measurement is triggered when a timer expires. The throughput measurement triggering may be delayed until ongoing traffic through the gateway may fall below a predefined threshold. If throughput measurement is triggered, the agent 130 begins throughput test.

In embodiments, the throughput is measured by moving a large file between the server 100 and the agent 130. For downstream throughput measurement, the agent 130 may download a large file from a server. For upstream throughput measurements, the agent 130 may (create and) use a large file to upload it to the server. It is noted that that the server for throughput test could be different from the server 100 and may comprise any type of web server that allows upload and download of large files. Since a large file transfer may degrade the performance of payload traffic, in embodiments, throughput measurement triggering may be delayed until the ongoing payload traffic in the gateway drops below a threshold.

According to various embodiments of the present disclosure, the agent 130 may be integrated within a gateway and may function as a proxy server for LAN devices behind the NAT so as to allow other LAN devices behind the NAT to connect to the server without requiring that each LAN device perform NAT traversal operations. In this example, the agent 130 may be positioned behind a NAT and maintain a connection to an external server by periodically exchanging packets. The agent 130 may run a proxy server that receives communication packets from other LAN devices, relay the packets to the destination outside the home network, receive packets whose destination are to LAN devices, and relay the packets to the corresponding LAN devices. For example, a socket secure protocol (“SOCKS”) may be utilized as a proxy server. When relaying a packet, the agent 130 may use the local address and port pair that was previously used, e.g., for NAT hole punching. As a result, not all LAN devices need to perform NAT traversal operations.

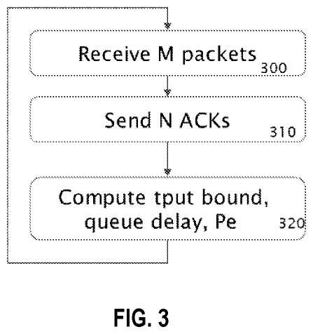

FIG. 3 is an exemplary flowchart illustrating a method for monitoring a communication link at a server according to various embodiments of the present disclosure. The server 100 may be coupled to the agent 130 to continuously monitor the agent 130 and determine whether the broadband connection 150 supports a service type of interest, while, at the same time, enabling NAT traversal. At step 300, the server 100 may receive packets from the agent 130 and measure received timestamps. At step 310, the server may send N acknowledge packets to the agent 130. In embodiments, the packet sent by the server 100 may be the same and comprise some of the same information as that sent by the agent 130, e.g., as shown in FIG. 4, which illustrates an exemplary probing packet structure according to various embodiments of the present disclosure.

Returning to FIG. 3, in embodiments, the packet sent by the server 100 may comprise the sequence number and the timestamp written in the received packets. At step 320, the server 100 may derive communication performance from the timestamp obtained at step 300 and the information contained in the received packet. In embodiments, the communication performance comprises queue delay, latency, probability of error, lower bound of the upstream throughput, and a probability that the upstream throughput is below a threshold defined as the minimum upstream throughput that supports certain services such as IPTV. One skilled in the art will recognize that communication performance may comprise other and/or additional parameters relevant to the communication link.

The server 100 starts to wait for the packets from the agent 130. In embodiments, the server 100 may provide a web service for large file upload and download that can be used by the agent 130 to measure the upstream and downstream throughput.

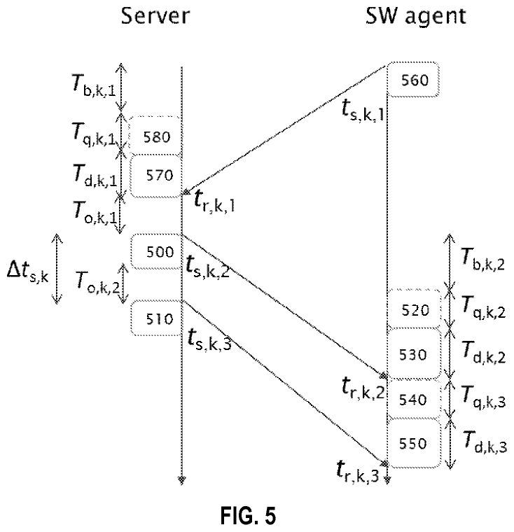

FIG. 5 depicts an operation for estimating broadband performance characteristics of a communication link, according to various embodiments of the present disclosure. Characteristics may comprise queue delay, latency, RTT, probability of error, throughput, and the probability that the throughput is below a threshold where the threshold is the minimum throughput to support certain services such as IPTV.

As depicted in FIG. 5, the agent 130 transmits one packet with B_{U} bytes to the server 100, and the upstream throughput without a load is R_{U} kbps. The server 100 transmits two packets with B_{D} bytes to the agent 130, and the downstream throughput without a load is R_{D} kbps. Because the measurement involves a small number of packets, it does not affect the quality of payload traffic. In FIG. 5, t denotes timestamp, and T denotes time duration. The time measurements may contain, e.g., three subscripts, each separated by comma with the first subscript denoting the type, the second subscript denoting a batch index, and the last subscript denoting a sequence number. The five types of letters represent: t for transmit, r for receive, q for queue delay, d for dispersion, b for baseline delay, o for processing delay, such as processing delay such as OS latency. The batch index k indicates that it is the k-th packet exchanged between the server and the agent 130. The sequence number is the index for the packets within a batch, starting from 1. For ease of explanation, it is assumed that the sequence numbers for upstream and downstream are counted together per batch, which is different from the sequence number in the probing packet structure in FIG. 4. For example, t_{t,k,n}/t_{r,k,n} denotes the transmit/receive timestamp of the n-th packet during the k-th packet exchange between server 100 and agent 130. Similarly, T_{q,k,n} denotes the queueing delay of the n-th packet during the k-th packet exchange.

The estimate of delays is denoted as D_{a,b,k} where a denotes either downstream D or upstream U, b denotes the type, and k is either the batch number (if it is an instantaneous estimate) or the statistics type (if it is a statistic obtained using estimates from multiple batches). The following types are used for D: q for queue delay, d for dispersion, b for baseline delay, o for OS delay, w for one way delay. Note that D is used to represent “estimate” and T is used to denote ground truth. For example, D_{U,w,k} is the estimate of the upstream one-way delay for k-th batch. In embodiments, the agent 130 counts the number of packet drops based on sequence number and measures the packet loss rate by dividing the number of packet drops by the number of received packets.

In embodiments, the agent 130 may transmit a packet 560 with transmit timestamp t_{s,k,1} as shown in the FIG. 5. The packet may arrive at the server 100 at time t_{r,k,1}. The upstream baseline delay, i.e., the delay from agent 130 to the server when there is no traffic, may be T_{b,k,1}. When there is cross-traffic 580 in the path, the packet may be further delayed by queueing delay T_{q,k,1}. The received packet 570 may be dispersed by T_{d,k,1} due to finite upstream bandwidth R_{U} where T_{d,k,1}=8*B_{D}/R_{D} msec. The server 100 and the agent 130 are oftentimes not time-synchronized; therefore, the timestamp in the server 100 and the agent 130 have a clock offset T_{Δ} that may fluctuate over time but is relatively stable when compared to the queuing delay and, thus, has no batch index. Then t_{s,k,1}−t_{r,k,1}=T_{b,k,1}+T_{q,k,1}+T_{d,q,1}+T_{Δ}. In embodiments, the server 100 spends time T_{o,k,1} to prepare the packets 500 and sends the packets 500 and 510 to the agent 130 at time t_{s,k,2} and t_{s,k,3}, respectively. Δt_{s,k}=t_{s,k,3}−t_{s,k,2} is the time between two consecutive packet transmissions.

Packets 530 and 550 may correspond to the transmitted packets 500 and 510 and they may be received at respective times t_{r,k,2} and t_{r,k,3}. Similar to the upstream condition, the downstream baseline delay is T_{b,k,2}. In embodiments, when there is cross-traffic 520 in the path, the packet 530 may be further delayed by queueing delay T_{q,k,2}. The received packet 530 may be dispersed by T_{d,k,2} due to finite bandwidth R_{D} where T_{d,k,2}=8*B_{D}/R_{D} msec. Similarly, when there is cross-traffic 540 in the path, the packet 550 may be further delayed by queueing delay T_{q,k,3}. The received packet 550 may be dispersed by the same 8*B_{D}/R_{D} msec if the packets 530 and have same size and if the downstream throughput R_{D} is unchanged.

Using these measurements, various embodiments of the present disclosure may derive the upstream one-way delay as:

D_{U,w,k}=t_{r,k,1}−t_{s,k,2}=T_{b,k,1}+T_{q,k,1}+T_{d,l,1}+T_{Δ}

The server may estimate the D_{U,w,k} using timestamp t_{s,k,1} written in the packet 560. It is noted that the one-way delay estimate D_{U,w,k} may be inaccurate due to clock offset T_{Δ}. However, in embodiments, queuing delay and delay jitter may be relatively accurately estimated even with clock offset, e.g., by using statistical analysis methods.

First, the minimum one-way delay may be defined as D_{U,w,min}=min_{k=1, . . . ,K}D_{U,w,k}. Over an extended period of time, the upstream path and upstream throughput may remain unchanged. In this example, the baseline delay and dispersion may be constant over a measurement period, and thus drop batch index k, i.e., T_{b,k,1}=T_{b,1}, T_{d,k,1}=T_{d,1}, for ∀k. Then, D_{U,w,min}=D_{U,w,k} for k when the queueing delay is zero, i.e., T_{q,k,1}=0. Therefore, D_{U,w,min}=T_{b,1}+T_{d,1}+T_{Δ}.

The estimate of queueing delay at packet k is equal to D_{U,q,k}=D_{U,w,k}−D_{U,w,min}. Since the queueing delay typically increases with queues in the upstream path, queueing delay may be used as a good indicator of congestion in the upstream path. Likewise, one may define one-way delay jitter as D_{U,w,jitter}=std(D_{U,w,k})=std(T_{q,k,1}), where std(X) represents the standard deviation of the random variable X, because T_{b,1}+T_{d,1}+T_{Δ} nearly constant. Thus, the one-way delay jitter may be used as a good indicator of poor multi-media communication performance.

The downstream one-way delay estimate is:

D_{D,w,k}=t_{s,k,2}−t_{r,k,2}=T_{b,2}+T_{q,k,2}+T_{d,2}−T_{Δ};

the downstream minimum delay estimate is D_{D,w,min}=min_{k=1, . . . ,K}D_{D,w,k};

the downstream queue delay estimate is D_{D,q,k}=D_{D,w,k}−D_{D,w,min}; and

the downstream one-way delay jitter is D_{D,w,jitter}=std(D_{D,w,k})=std(T_{q,k,2}).

Note that the agent 130 can measure downstream queue delay and jitter if the transmit timestamp t_{s,k,2} is present in the transmitted packet 500. Further note that the one-way delay measured using the second downstream packet 510 may be inaccurate if T_{q,k,2}+T_{d,2}>Δt_{s,k}, because t_{s,k,3}−t_{r,k,3}=T_{b,2}+T_{q,k,2}+T_{d,k,2}+T_{d,k,31}+T_{q,k,3}−Δt_{s,k}−T_{Δ}, which is affected by both queuing delays and Δt_{s,k}. Therefore, In embodiments, the one-way delay may be analyzed by using only the first received packet if the queue delay of the first packet is larger than a threshold, which may be Δt_{s,k}−T_{d,k,2}.

One skilled in the art will recognize that the equations and mathematical expression herein are intended to be representative of certain embodiments. Other variations of the present disclosure may be described by other and/or additional equations and variables.

In embodiments, the agent 130 may derive the upstream queue delay and upstream delay jitter from RTT, downstream queue delay, and downstream delay jitter; therefore, the upstream measurement by the server 100 does not need to be written in transmitted packet 500.

First, the agent 130 may measure RTT as:

RTTₖ=t_{r,k,2}−t_{s,k,1}=T_{b,1}+T_{q,k,1}+T_{d,k,1}+T_{o,k,1}+T_{b,k,2}+T_{q,k,2}+T_{d,2}

which is independent of clock offset T_{Δ}. The minimum RTT may be defined as RTTₘᵢₙ=min_{k=1, . . . ,K}RTTₖ in certain examples, and the sum of queue delay in both direction is D_{DU,q,k}=RTTₖ−RTTₘᵢₙ=T_{q,k,1}+T_{q,k,2} because the routing path, upstream/downstream rate, and the time a server prepares a packet, T_{o,k,1}, are relatively constant over a length of time. In embodiments, the agent 130 may compute the upstream queue delay as D_{U,q,k}=D_{DU,q,k}−D_{D,q,k}, e.g., if D_{U,q,k} is not in packet 500. The RTT jitter may be computed as RTTⱼᵢₜₜₑᵣ=std(RTTₖ)=std(T_{q,k,1}+T_{q,k,2}). Since the upstream and downstream queue delays are often uncorrelated, the upstream delay jitter D_{U,w,jitter} may be estimated from RTT jitter as D_{U,w,jitter}=\sqrt{RTTⱼᵢₜₜₑᵣ²−D_{U,w,jitter}²} and, thus, the agent 130 does not need to obtain the server's upstream delay jitter estimate in packet 500. Again, the mathematical expressions and representations are intended to be representative of examples of embodiments, there may be other embodiments that are defined mathematically differently.

In embodiments, the agent 130 may derive downstream throughput by analyzing the dispersion to identify the lower bound of the access network speed. The agent 130 may estimate the downstream dispersion from the difference of two timestamps received in the agent 130, i.e., D_{D,d,k}=t_{r,k,3}−t_{r,k,2}=T_{q,k,3}+T_{d,k,3} and may estimate a downstream bottleneck throughput as \hat{R}_{D,k}=B_{D}/D_{D,d,k}. In embodiments, the agent 130 may discard the downstream bottleneck throughput estimate, e.g., if D_{D,q,2}>Threshold. If the bottleneck is located at the end of the path, \hat{R}_{D,k} may represent the lower bound of actual throughput R_{D,k}. Because the agent 130 is coupled to the access network portion of the broadband connection, such as DSL and Cable, and the access network tends to be the bottleneck link for broadband connection, \hat{R}_{D,k} may be the lower bound of downstream throughput of access network. In the gateway, the agent 130 may have access to a counter that measures the number of bytes that the gateway receives during a certain period of time. In embodiments, the agent 130 may use such a counter in lieu of B_{D}, the number of bytes in the downstream transmit packet, e.g., to improve the accuracy of the throughput estimation.

In embodiments, the agent 130 may be aware of the minimum downstream rate that LAN devices use, denoted as R_{D,req}, which aids in identifying a likelihood that the throughput is below the threshold. For example, if a user watches HDTV streaming at a rate of 6 Mbps and using LAN device 140-1, the minimum downstream throughput of the access network R_{D,req} is 6 Mbps. If \hat{R}_{D,k}≥R_{D,req}, the access network has sufficient downstream capacity to support the user service. If \hat{R}_{D,k}<R_{D,req}, it is possible that the access network does not have enough downstream capacity to support such user service since \hat{R}_{D,k} is the lower bound of the access network capacity. In embodiments, e.g., based on historical data, P(R_{D,k}≥R_{D,req}), the probability that the downstream access network provides enough capacity for user service at k-th batch may be computed, where P(R_{D,k}≥R_{D,req})=1 if \hat{R}_{D,k}≥R_{D,req}, and is a monotonically decreasing function of R_{D,req}−\hat{R}_{D,k} if \hat{R}_{D,k}<R_{D,req}.

In embodiments, the agent 130 may estimate accurate downstream throughput of a broadband connection if a trigger condition 240 is satisfied. Accurate downstream throughput is an important parameter to monitor in order to ensure that an ISP honors its SLA (Service Level Agreement), e.g., the broadband speed that an ISP promises to deliver to the user. Oftentimes, broadband speed is limited not by the capacity of the access network but rather by a traffic shaper that delays the downstream packet if the traffic shaper's queue is full, e.g., the gateway receives more than a certain number of bytes over certain a period of time. A measurement system should send a sufficient number of bytes/packets to trigger the traffic shaping to monitor the downstream broadband speed.

In embodiments, the server 100 may transmit N packets to the agent 130 and then compute the broadband speed as \hat{R}_{D,max}=maxₖ(N−1)B_{D}/(t_{r,k,N+1}−t_{r,k,2}). In embodiments, the server 100 may start to transmit 2 packets (N₁=2) for the first batch and transmit more packets (e.g., Nₖ=2*Nₖ) until (N−1)B_{D}/(t_{r,k,N+1}−t_{r,k,2}) starts to decrease in the absence of queuing delay. In yet another embodiment, each batch of measurements may be repeated to improve the accuracy of the estimate. It is noted that this process reduces disruption to the payload traffic since only the last measurement would trigger traffic shaping. Assuming, for example, that L measurements are performed and that each measurement uses twice as many packets as the immediately preceding measurement. Since this increases the number of packets until the Internet speed decreases, which means traffic shaping was triggered, only the last measurement would have triggered the traffic shaping. Therefore, for the first L−1 measurements, the payload traffic would not have been affected by the traffic shaping, i.e., disruptions to the payload traffic are significantly reduced.

In embodiments, the agent 130 may estimate accurate throughput of the broadband connection by transferring a large file between the agent 130 and the server 170. For example, if a file with B kBytes are transferred from the speedtest server 170 to the agent in t1 seconds, the agent 130 may estimate the downstream broadband throughput as B*8/t1 Kbps. If a user uses the broadband connection during the measurement, such a large file transfer may degrade the performance user payload traffic. The agent 130 may first ascertain the presence of ongoing user payload traffic. In embodiments, the agent 130 may read the number of bytes that the gateway has received from the broadband connection over the last t2 seconds, and declares that there was user payload traffic in the downstream direction if the received number of bytes is greater larger than a threshold and defer the triggering of an accurate downstream throughput measurement. However, the absence of user payload traffic for those t2 seconds may not ensure the absence of any new user payload traffic during the measurement. In embodiments, to minimize the impact of a large file transfer on new user payload traffic, the agent 130 may use the lower-than best-effort transport protocol, which automatically yields to TCP flows. In embodiments, the agent 130 and speedtest server 170 use LEDBAT as the transport protocol.

As previously mentioned, embodiments of the present disclosure may be used to monitor whether an ISP provides an Internet speed that is set forth by an SLA. For example, the SLA may specify a certain download speed, R_{down}, for a given time. To determine whether the specified speed in the SLA is met, R_{down} may be compared to a current Internet download speed, x(t), using existing Internet speed test tools. However, such existing methods have three main problems:

First, if R_{down} is high, the speed test requires a relatively large amount of data; thus, consuming a relatively large amount of Internet bandwidth. For example, if R_{down} is 1 Gbps and the duration or a test is 1 second, the speed test may require the transfer of 125 MB of data.

Second, during the speed test, the quality of Internet services may degrade since the user payload traffic has to share bandwidth with the speed test traffic; especially, if both have the same priority (e.g., when both use the TCP protocol), then user payload traffic may suffer packet loss and an unwanted reduction in speed.

Third, Internet service quality may change over time. For example, a greater number of users may use Internet services in the evenings, such that SLA download speed requirements may be not met at certain times of the day. As another example, during certain times, radio interference may be present, again, resulting in the specified download speed not being met. As a result, infrequent speed tests may not be able to detect an existing discrepancy between R_{down} specified in the SLA and the actual download speed.

Embodiments, of the present disclosure address the above-mentioned problems in several ways:

(1) Instead of measuring Internet speed up to a maximum R_{down}, certain embodiments determine whether test packets in addition to the user payload traffic may be successfully transmitted between an agent and a server. If additional test packets may be transmitted without affecting user payload traffic quality, it may be concluded that an ISP does not apply throttling to the user payload and that, thus, the user's Internet experience is not affected by, e.g., the download speed specified in the SLA, R_{down}.

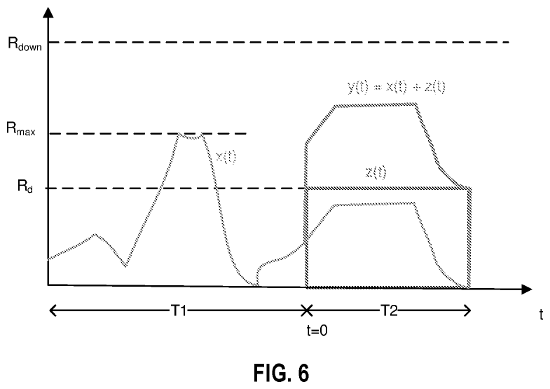

To illustrate how certain embodiments test whether additional test packets may be transmitted, the following assumptions may be made with reference to FIG. 6 that illustrates an exemplary speed of Internet payload traffic and Internet speed test according to various embodiments of the present disclosure:

Tₛ denotes a sampling interval for a speed measurement (e.g., one sample taken every second). Note that for ease of presentation uniform (equidistant) sampling is assumed. In practice, sampling interval Tₛ may be adapted according to a payload traffic pattern and/or previously obtained Internet speed test results. It is also noted that presented downstream speed measurements and tests are merely exemplary. Similarly, the presented methods may equally be used for upstream speed tests.

x(n) denotes, within a measurement window in sampling interval Tₛ where n represents the sample index, the average speed of payload downstream traffic that is the sum of Internet download bandwidths used by all downstream payload services at time (n−1)Tₛ≤t<nTₛ.

z(n) denotes the Internet downstream speed test at time (n−1)Tₛ≤t<nTₛ.

T1 denotes the duration of the sampling interval (e.g. 60 sec.) when a characteristic of the payload traffic is monitored.

N1 is the number of payload traffic downstream speed samples, N1=T1/Tₛ.

N2 is the number of Internet downstream speed test samples, N2=T2/Tₛ, and t=0 indicates the time when the speed test starts. T2 denotes the speed measurement interval duration.

Rₘₐₓ(T1) is the maximum downstream user payload traffic speed between T1≤t<0 in the absence of speed test traffic, which is the same as max(x(n)), N1≤n<0.

R_{down} is the download speed specified, e.g., in the SLA.

The problem is to detect whether Rₘₐₓ(T1)=max(x(n)) over N1≤n<0 was throttled by the ISP.

Note that z(t) is less than Rₘₐₓ, the maximum payload speed between −T1≤t<0 or the download speed R_{down} specified in the SLA; however, the sum of the payload downstream rate and the speed test downstream rate may be higher than Rₘₐₓ.

To test this hypothesis, in embodiments, an agent may download packets at the rate of z(n), such that

max(z(n))=R_{d} over 0≤n<N2 where R_{d}≤Rₘₐₓ(T1) and R_{down}.

Optionally, sum(z(n)+x(n), 0≤n<=N2)≥Bₛ, where Bₛ is the minimum data size that triggers traffic shaping.

Note that z(n) is smaller than Rₘₐₓ(T1) and R_{down}. In prior art systems, z(n) is greater than R_{down} and oftentimes unlimited. Therefore, embodiments of the present disclosure use a lower amount of download traffic to measure the Internet speed.

In embodiments, if z(n)+x(n)≥(Rₘₐₓ(T1)+Threshold), or any statistics applied to (z(n)+x(n)) is ≥Rₘₐₓ(T1), it may be concluded that additional test packets may be downloaded over the Internet, i.e., the Internet service was not throttled.

Conversely, if z(t)+x(t), or any statistics applied to (z(n)+x(n)) is <(Rₘₐₓ(T1)+Threshold), in embodiments, it may be concluded that the Internet service may have been throttled. When this event is detected, optionally, the Internet download speed may be tested without a rate limit or with a rate limit at R_{down}, which may be the download speed specified by an SLA. In embodiments, if this Internet download speed test shows that the measured Internet download speed is less than the specified R_{down}, it may be concluded that the download speed in the SLA is not met.

In embodiments, R_{d}, the download speed for the Internet speed test samples, N2, and the Threshold may be configured based on statistics of the speed of payload downstream traffic, x(n), and the number of samples to determine statistics of the payload traffic speed samples N1. As an example, assuming that Internet speed was measured by uniform sampling within a sampling interval Tₛ, and further assuming a Gaussian distribution of x(n) over −N1≤n<0 having a standard deviation Rₛ and an average Rₐ, then, the probability that x(n)+R_{d}≥Rₘₐₓ(T1)+Threshold at each sample n is 16% if R_{d} is set to Rₘₐₓ(T1)+Threshold−Rₐ−Rₛ. Assuming that x(n) are independent and identically distributed random variables, and R_{d} is set to Rₘₐₓ(T1)+Threshold−Rₐ−Rₛ, then the probability that x(n)+R_{d}>Rₘₐₓ(T1)+Threshold at least once for 0≤t<N2 is 1−(1−0.15)^{N2}. Based on this relationship, N2 and R_{d} may be selected such that they provide a target detection probability. For example, given R_{d}, N2 may be set by setting 1−(1−0.15)^{N2} such as to have a certain desirable probability p if R_{d} was set as Rₘₐₓ(T1)+Threshold−Rₐ−Rₛ. If R_{d} is set differently, N2 may be empirically determined or by using any method known in the art. Likewise, Threshold may be set to adjust a confidence interval. Assuming user traffic is random, as a person skilled in the art will appreciate, the confidence interval of the statistics of measured traffic speed may be computed given N1 repeated measurements. For example, instead of using the maximum of the payload traffic speed, the confidence interval of the maximum traffic speed may be computed and used for setting Rmax(T1).

In embodiments, the sampling interval, Tₛ, or the sampling method in general may be adapted based on the line characteristics. For example, if the RTT between an agent and a speed test server is relatively long, Tₛ may be increased in order to mitigate the impact of a TCP slow start. In another example, if the user payload traffic is bursty, or the number of Internet users is large, then Tₛ should be set relatively short to capture the bursty behavior.

(2) To minimize the impact on user payload traffic, in embodiments, the Internet speed test packets may use a lower-than-best-effort transport protocol such as LEDBAT.

(3) Due to the conditions in (1) and (2), Internet speed need not be continuously monitored. Therefore, in embodiments, an Internet speed test is triggered when it is likely that the Internet speed is throttled.

In embodiments, machine learning methods may be employed to learn when and how to trigger an Internet speed test. An exemplary machine learning method may use features that have been extracted from user payload traffic speed x(n), previous speed test results, non-invasive speed test (e.g., packet pairing, packet dispersion measurement, or RTT measurement) results, and other features that may be collected by an agent to determine a likelihood that Internet speed is throttled. For example, if the maximum user payload speed v[k]=max(x[n]) may be measured every minute, where k represents a sample index within K maximum user payload speed measurements used for testing the likelihood of Internet throttling, and if max(v[k])−min(v[k]) is small for K minutes, e.g., K=5 minutes (during which the maximum user payload speed is determined 5 times), then it is more likely that the Internet speed is throttled at a speed equivalent to max(v[k]).

In embodiments, if a non-invasive speed test detects a burst of packet loss, it is determined that it is more likely that the Internet speed has been throttled. In embodiments, by applying machine learning methods that use, for example, logistic regression, the likelihood of Internet speed throttling may be estimated and then a speed test may be triggered in response to the likelihood being greater than a given threshold.

In embodiments, the triggers for Internet speed tests for different agents may be coordinated such as to enhance the diagnostics of network problems and enable SLA violation detection. Six exemplary use cases of such coordination are discussed next:

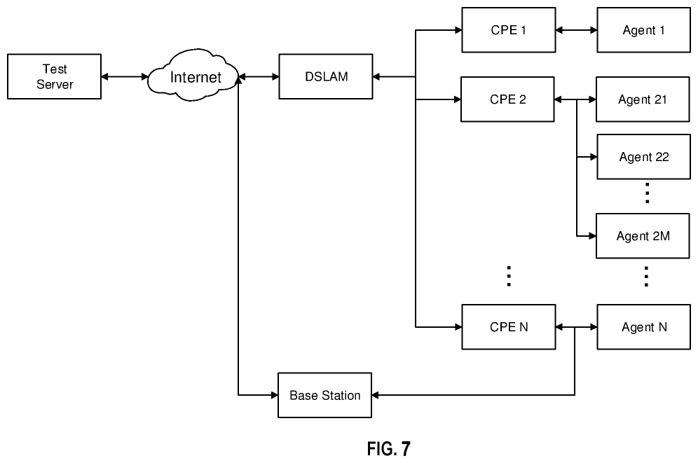

(1) In typical access networks, many access lines such as DSL, PON, and Cable Internet are connected to a network aggregation unit such as DSLAM, ONU, and cable head-end, as shown in FIG. 7, which illustrates an exemplary system for speed of Internet payload traffic and Internet speed test, according to embodiments of the present disclosure.

Then, traffic from a plurality of lines may be connected to the Internet via a single aggregated line. For example, many lines coupled to the same access network may connect to the Internet via an access aggregation unit, such as a DSLAM. In another example, many wireless lines may be connected to a base station that connects to the Internet. Therefore, when the users connected to the access network aggregation unit consume a large bandwidth, the single aggregated line may represent a bottleneck. Therefore, in embodiments, when a trigger condition is satisfied, e.g., in one of the agents, then more than one of the agents sharing the same network aggregation unit may initiate an Internet speed test, such that the connection between the network aggregation unit and the Internet can be tested.

(2) Since a speed test uses a significant amount of Internet bandwidth, this may create network congestion if many network nodes run speed tests at the same time. Therefore, various embodiments distribute the speed test load across a network such as to avoid congestion. In embodiments, Internet speed tests may be scheduled such that only a relatively small number of agents that share the same access network simultaneously are permitted to run the speed test.

(3) If a user experiences a network problem, certain embodiments determine the location of the problem by measuring the speed between different nodes in the network. In embodiments it is determined whether the problem is caused by a Wi-Fi problem or an access network problem. To identify the problem, two or more Internet speed test agents that are coupled to the gateway (or CPE) may simultaneously start an Internet speed test, e.g., if a trigger condition is satisfied. If the access network is identified as the source of a problem, all agents involved in the Internet speed test may be assigned a lower-than historically normal speed. Conversely, if the Wi-Fi is identified as the problem, some agents may be assigned a normal speed, while the agent that triggered the Internet speed test may be assigned a lower-than historically normal speed. The test server and agent may be located at the access aggregation unit. To identify the problem, embodiments may measure (1) the speed between access aggregation node and Internet and (2) the speed between the access aggregation node and CPE; and attribute the problem to an access network if measurement (2) indicates a problem.

(4) To test relatively high maximum speed, e.g., 1 Gbps, it may be difficult for one agent to transmit and receive high speed communication flow due to hardware/software limitations such as CPU, memory, and OS. To solve this issue, in embodiments, two or more Internet speed test agents connected to and/or embedded into a gateway (or CPE) may simultaneously start an Internet speed test if the trigger condition is satisfied. Since multiple agents are transmitting and receiving data, it is easier to reach relatively high data rates, e.g., 1 Gbps. In embodiments, a speed test involving multiple agents may be coordinated by an agent at the gateway/CPE or by a server.

(5) When there is more than one test server, in embodiments, two Internet speed triggers, e.g., each corresponding to a different test server, may be coordinated such as to detect the location of the network problem. For example, when the Internet speed test result measured between an agent and the test server in FIG. 7 is relatively low, then a speed test with another test server (not shown) may be triggered. If the result is consistent, it is likely caused by a broadband speed issue. If not, the result is likely not caused by a broadband speed issue.

(6) In embodiments, when an agent has more than one broadband connection, the triggers for the broadband connections may be coordinated. For example, assuming that the speed tests are triggered for all broadband connections, the difference of the ratio of different speed test results may indicate some Internet speed throttling in one of the broadband connections.

In embodiments, the Internet speed test agents may coordinate with each other or they may be coordinated by a number of test servers. For example, a test server may receive speed test trigger(s) from local or remote agents and send speed test triggers to more than one of the agents that are connected to the same access network aggregation unit. In another example, an agent may send triggers to all agents connected to the same access network aggregation unit or CPE.

It is understood that there may be many possible ways to identify the agents connected to the same access network aggregation unit. For example, in embodiments, ICMP traceroute may be used to discover the host name of an adjacent network node. In another example, one may send LAN broadcast packets to discover agents that are connected to the same LAN.

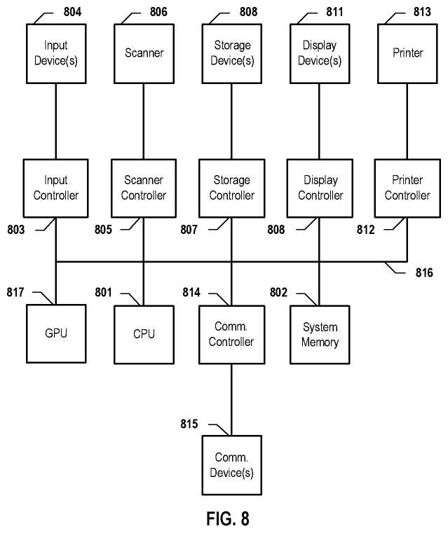

FIG. 8 depicts a simplified block diagram of a computing device, in accordance with embodiments of the present disclosure. It will be understood that the functionalities shown for system 800 may operate to support various embodiments of a computing system—although it shall be understood that a computing system may be differently configured and include different components, including having fewer or more components as depicted in FIG. 8.

As illustrated in FIG. 8, the computing system 800 includes one or more central processing units (CPU) 801 that provides computing resources and controls the computer. CPU 801 may be implemented with a microprocessor or the like, and may also include one or more graphics processing units (GPU) 819 and/or a floating-point coprocessor for mathematical computations. System 800 may also include a system memory 802, which may be in the form of random-access memory (RAM), read-only memory (ROM), or both.

A number of controllers and peripheral devices may also be provided, as shown in FIG. 8. An input controller 803 represents an interface to various input device(s) 804. The computing system 800 may also include a storage controller 807 for interfacing with one or more storage devices 808 that might be used to record programs of instructions for operating systems, utilities, and applications, which may include embodiments of programs that implement various aspects of the present invention. Storage device(s) 808 may also be used to store processed data or data to be processed in accordance with the invention. The system 800 may also include a display controller 809 for providing an interface to a display device 811, which may be a cathode ray tube (CRT), a thin film transistor (TFT) display, organic light-emitting diode, electroluminescent panel, plasma panel, or other type of display. The computing system 800 may also include one or more peripheral controllers or interfaces 805 for one or more peripherals. Example of peripheral may include one or more printers, scanners, input devices, output devices, sensors, and the like. A communications controller 814 may interface with one or more communication devices 815, which enables the system 800 to connect to remote devices through any of a variety of networks including the Internet, a cloud resource (e.g., an Ethernet cloud, a Fiber Channel over Ethernet (FCoE)/Data Center Bridging (DCB) cloud, etc.), a local area network (LAN), a wide area network (WAN), a storage area network (SAN) or through any suitable electromagnetic carrier signals including infrared signals.

In the illustrated system, all major system components may connect to a bus 816, which may represent more than one physical bus. However, various system components may or may not be in physical proximity to one another. For example, input data and/or output data may be remotely transmitted from one physical location to another. In addition, programs that implement various aspects of the invention may be accessed from a remote location (e.g., a server) over a network. Such data and/or programs may be conveyed through any of a variety of machine-readable media.

Aspects of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using application specific integrated circuits (ASICs), programmable arrays, digital signal processing circuitry, or the like. Accordingly, the terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present invention may further relate to computer products with a non-transitory, tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks; optical media such as CD-ROMs and holographic devices; magneto-optical media; and hardware devices that are specially configured to store or to store and execute program code, such as ASICs, programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present invention. One skilled in the art will also recognize that a number of the elements described above may be physically and/or functionally separated into sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A method for periodically monitoring communication link performance:
transmitting packets from a communication device to a server;
receiving at the communication device, via a network that comprises a communication link, an acknowledgement packet transmitted by the server, the acknowledgement packet comprising a transmit timestamp;
determining, by the communication device, an arrival time of the acknowledgement packet;
using the arrival time and the transmit timestamp to derive a communication performance metric;
determining whether a trigger condition has been met; and
in response to the trigger condition being met, triggering a performance measurement associated with the communication link.

2. The method according to claim 1, further comprising, in order to reduce a degradation in payload traffic performance, delaying triggering until a payload traffic in a gateway satisfies a threshold.

3. The method according to claim 1, wherein the performance measurement comprises an upstream or downstream throughput performance measurement that comprises transferring a file between a speed test server and the communication device.

4. The method according to claim 3, wherein a proxy server is embedded in a gateway that allows LAN devices to connect to the speed test server without requiring that each LAN device perform a NAT traversal operation.

5. The method according to claim 1, wherein the communication performance metric comprises one of a queue delay, a latency, a round-trip-time, a probability of error, a lower bound of downstream throughput, or a probability that a downstream throughput is below a threshold defined by a minimum downstream throughput associated with a service.

6. The method according to claim 1, further comprising, in response to determining that no prior knowledge about a NAT binding timeout exists:
triggering at different periods, monitoring acknowledgement packets from the server; and
determining a periodicity with which the communication device receives the acknowledgement packets from the server.

7. The method according to claim 1, wherein two or more agents that share a same network aggregation unit initiate an Internet speed test to test a connection between the network aggregation unit and the Internet.

8. The method according to claim 1, wherein, in response to the trigger condition being met, two or more agents that are coupled to a gateway or CPE simultaneously initiate the Internet speed test.

9. The method according to claim 1, further comprising coordinating a plurality of Internet speed triggers corresponding to a plurality of test servers to detect both a location of a network problem and an SLA violation.

10. The method according to claim 1, wherein determining whether a trigger condition has been met comprises:
comparing a metric associated with a user payload traffic speed to the sum of both an average speed of a payload traffic and the speed of a speed test traffic; and
based on the comparison, determining whether throttling of Internet speed has likely been applied to a user payload traffic.

11. The method according to claim 10, further comprising, in response to determining that the metric is greater than the average of the sum of speed of the payload traffic and the speed of the speed test traffic, concluding that a specified download speed has not been met.

12. The method according to claim 10, further comprising selecting a sampling interval based on one or more line characteristics to capture a burst of the user payload traffic or to mitigate an impact of a TCP slow start.

13. The method according to claim 10, wherein determining whether throttling of Internet speed has been applied to the user payload traffic comprises one of detecting a burst of packet loss by a non-invasive speed test and determining that the user payload traffic would be substantially affected by transmitting additional packets between an agent and a server in a network, the non-invasive speed test results comprise one of packet pairing, a packet dispersion measurement, or a round-trip-time measurement.

14. The method according to claim 10, wherein transmitting packets comprises using a Low Extra Delay Background Transport protocol to reduce a degradation of a user payload traffic performance caused by a throughput measurement.

15. The method according to claim 10, further comprising, in response to determining that throttling of Internet speed has likely been applied to the user payload traffic or a specified download speed has not been met, initiating an Internet speed test that comprises downloading a file.

16. The method according to claim 10, further comprising using a machine learning method to extract features from one of the user payload traffic speed, a previous speed test result, and a non-invasive speed test result to estimate a likelihood that throttling of Internet speed has been applied to the user payload traffic.

17. A method for assessing communication link performance, the method comprising:
at a server, receive a packet that has been transmitted by a communication device via a network that comprises a communication link, the received packet comprising a timestamp and an identifier;
measuring a time of arrival of the received packet;
sending to the communication device an acknowledgement that comprises at least one of a receive timestamp, a receive identifier, or a sequence number, such that the communication device can measure an arrival time of the received packet; and
using the timestamp and the arrival time to derive a communication performance, the communication device triggers, in response to a trigger condition being met, a performance measurement associated with the communication link.

18. A system for periodically monitoring communication link performance while enabling Network Address Translation (NAT) traversal operations, the system comprising:
using an agent to measure a packet dispersion by transmitting and receiving packets to and from a server;
based on the packet dispersion, determining a lower bound of throughput; and
comparing the lower bound of throughput to a minimum required data rate of a service to determine whether an access network supports a certain service type.

19. The system according to claim 18, wherein packets comprising a timestamp that is used to determine a performance of a broadband connection and an identifier are transmitted, via a network that comprises a communication link, from a first communication device measuring a time of arrival of the packets and being located behind the NAT to a second communication device that measures the time of arrival of a packet and acknowledges received packets by sending packets that comprise at least one of a receive timestamp, a receive identifier, or a sequence number.

20. The system according to claim 19, wherein, in response to a trigger condition being met, the first communication device triggers a measurement of throughput of the communication link by using a protocol that, in the presence of user payload traffic, adjusts a transmission rate to reduce interference with a user payload traffic performance.
